(19) United States
(12) Patent Application Publication
(10) Pub. No.: US 2024/0410496 A1
(43) Pub. Date: Dec. 12, 2024

(54) EXTRACTION DEVICE FOR THE REMOVAL OF PATHWAY CONDUITS FROM CONCRETE SLABS

(71) Applicant: Adrian RIVERA GONZALEZ, Ciudad de Mexico (MX)

(72) Inventor: Adrian RIVERA GONZALEZ, Ciudad de Mexico (MX)

(21) Appl. No.: 18/737,981

(22) Filed: Jun. 8, 2024

(30) Foreign Application Priority Data
Jun. 9, 2023 (MX) MX/U/2023/000223

(51) Int. Cl. F16L 1/06

(52) U.S. Cl. CPC F16L 1/06

(57) ABSTRACT

An extraction device to remove pathway conduits, which are embedded in hardened concrete slabs is arranged by a quadrangular main piece having lateral faces forming a curvature correlative to the diameter of the pathway conduit, and being cylindrical and freely rotatable inside the conduit. Towards the upper part of the quadrangular main piece, some sets of posts are deployed, showing a space between each set of posts, where the space between each set of posts, is occupied by a set of flat bars, placed in the center, held by a bolt, so that they can have movement, and turn to the sides, and have towards the upper end, a pointed spike. Towards the central part of the rectangular piece, there is an orifice through which a square coupling is placed, and which has a revision orifice and further down an inner thread as a fastener with a second square profile.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

An apparatus consisting of an extraction device to remove pathway conduits that are embedded in the hardened concrete slabs is disclosed.

The function of the device is to have a tool by means of which pathway conduits can be extracted from concrete slabs, leaving a hole free for the subsequent laying of pipes for the conduction of electrical and telephone wiring and water pipes.

At the same time, the extracted pathway conduit will be used again in another construction site, so that the device can be used as many times as possible, since the extraction device used to extract them does not damage them at the time of their separation from the concrete slabs.

### 2. Description of Related Art Including Information Disclosed Under 37 CFR 1.97 and 37 CFR 1.98.

The function of the device is to have a tool by means of which pathway conduits can be extracted from concrete slabs, leaving a hole free for the subsequent laying of pipes for the conduction of electrical and telephone wiring and water pipes.

At the same time, the extracted pathway conduit will be used again in another construction site, so that the device can be used as many times as possible, since the extraction device used to extract them does not damage them at the time of their separation from the concrete slabs.

The construction of multi-level buildings is generally carried out using reinforced concrete as structural material, both in floors and walls. In the process of constructing multi-level reinforced concrete buildings or structures, it is necessary to have several pathways or passages for a variety of mechanical and electrical services. For example, channels or conduits in reinforced concrete allow the passage of wiring, plumbing pipes and like services from one side of a concrete structure to the opposite side.

Many patents have been registered which are background to the proposed invention.

U.S. Pat. No. 963,544 (Graaf) titled “Form for concrete Conduit construction” published on Jul. 5, 1910, describes a concrete pipe construction method for passage of wires and plumbing.

U.S. Pat. No. 1,530,200 (Richardson et al) titled “System of wiring conduits for building construction”, describes semicircular conduits for passing electrical wiring, embedded in concrete slabs, with outlet boxes for future use.

U.S. Pat. No. 3,163,909 (Williams) titled “Conduit and outlet box locating unit” describes an outlet box attached to electrical wiring pipes, consisting of a fastening support, where said invention is placed in the underfloor.

All these prior patent examples of conduits and procedures for pathway conduits have several limitations. For example, in the case where pathway conduit process is not reusable, there is significant waste in terms of materials and costs. Even when a reusable conduit procedure is used, there are several limitations.

Likewise, whenever it is desired to fill the conduits once the services are installed in place, prior patent devices do not facilitate how this step can be accomplished.

Additionally, when pathway conduit procedures are removed, there is no way to easily include reinforcing material, such as rods to improve structural strength within the above-mentioned conduit hollow.

The proposed invention has the appropriate dimensions to be inserted into the pathway conduits and extracted from its source. As pathway conduits are constructed in various sizes, appropriate extraction devices are available for each size or dimension required.

Thus, to the best knowledge of the author of the present invention, no other invention comprising conduit devices for being embedded in concrete slabs is known of, so that the present invention should be considered as new.

### BRIEF SUMMARY OF THE INVENTION

The above mentioned extraction device is arranged by a quadrangular main piece, where its lateral faces comprise a curvature correlative to the diameter of the cylindrical pathway conduit, and will be able to rotate freely inside the conduit; towards the upper part of the main quadrangular piece, some sets of posts are deployed, presenting a separation between each set of posts, where the space between each set of posts, is occupied by a set of flat bars placed and fastened by a bolt, placed in the center, so that they can have movement and turn to the sides, and present towards the upper end, a pointed peak, whose function will serve to hold a crosshead that present the pathway conduits to be removed by rotating it. Towards the central part of the rectangular piece, it has an orifice through which a square coupling of considerable height will be placed, and which has a revision orifice and further down an interior thread as a means of fastening with a second square profile and which will be joined with a second square screw.

As the pathway conduits are in the concrete slabs and between them the height is considerable, the proposed device comprises a pipe handle and which can be joined by a plurality of pipe lengths forming a telescopic unit, which is mounted towards the bottom of the rectangular piece.

To be able to extract the pathway conduit, there is a handle, consisting of a crosshead with a lock, which is placed in conjunction with the telescopic tubes.

Preferably, the rectangular piece remains inside the pathway conduit cavity and is held in place by the spikes of the arms, which are inserted into the crosshead of the pathway conduit. Once tightened, it is simply rotated to extract the pathway conduit, where the piece has ridges that allow it to slide and rotate easily, on the outer surface and in this way, the piece will come out of the conduit.

Therefore, we can consider that the present invention has its field of action for the extraction of pathway conduits located in concrete slabs created for the pathway of straight connectors, electrical wiring, telephone wiring and plumbing pipes.

### BENEFITS OF THE INVENTION

This invention belongs to the field of the procedures for the passage of a conduit through concrete, in particular.

In the construction field, concrete is generally used as a structural material, both in floors and walls. In the process of building concrete structures, it is also common to adopt solutions to create routes through concrete for different mechanical and electrical services. Channels or conduits in concrete allow for the passage of wiring, plumbing pipes and similar services. The generality is the placement of purpose-built conduits, which are removed once the concrete has set.

Therefore, the object of the present invention is to have a device with which it is possible to extract said pathway conduits located in the concrete slabs, after having set.

Another object of the present invention is to have a device for the extraction of pathway conduits located at any height by means of the use of a device that is mounted by means of telescopic tubes and a handle that allows the extraction device to rotate, without damaging the final holes in the concrete slab.

It is another advantage of the extraction device, of the present invention, to be able to remove the pathway conduits inserted in the concrete slabs in a simple and easy way and without any breakage, to be used again as many times as possible and to be able to make an unlimited number of pathway conduits in concrete slabs, according to the planned project.

### BRIEF DESCRIPTION OF THE SEVERAL VIEWS OF THE DRAWINGS

FIG. 1 is a perspective view of a pathway conduit, which is placed in concrete slabs.

FIG. 2 is a rear view of a pathway conduit.

FIG. 3 is a perspective view of the extraction device according to the information disclosure.

FIG. 4 is a top plan view of the quadrangular flat base main body showing a set of posts according to the information disclosure.

FIG. 5 is a side elevation view of the quadrangular flat base main body showing the set of posts.

FIG. 6 is a front elevation view of the quadrangular main body showing the fastening and anchoring holes.

FIG. 7 is a top plan view of the quadrangular main body showing a set of two sets of posts with a spacing between each set of posts according to the information disclosure.

FIG. 8 is a rear elevation view of the quadrangular main body showing the element's attachment holes according to the information disclosure.

FIG. 9 is a side elevation view of an arm in accordance with the information disclosure.

FIG. 10 is a rear elevation view of the arm.

FIG. 11 is a perspective view of the arm with a sharp peak.

FIG. 12 is a perspective view representation of an top coupling in accordance with the information disclosure.

FIG. 13 is a sectional view of the top coupling.

FIG. 14 is a top plan view of the top coupling.

FIG. 15 is a perspective view of a triangular bolt in accordance with the information disclosure.

FIG. 16 is a top plan view of the triangular bolt.

FIG. 17 is a front elevation view of the triangular bolt.

FIG. 18 is a perspective view of some U-shape stringers in accordance with the information disclosure.

FIG. 19 is a front elevation view of the U-shape stringers.

FIG. 20 is a side elevation view of the U-shape stringers.

FIG. 21 is a perspective view of a crosshead to rotate the telescopic tubes in accordance with the information disclosure.

FIG. 22 is a front elevation view of a section of the telescopic tube in accordance with the information disclosure.

FIG. 23 is a front elevation view of the telescopic tube's female end.

FIG. 24 is a front elevation view of the telescopic tube's male end.

FIG. 25 is a perspective view of the arm together with the compression spring and the opening bolt.

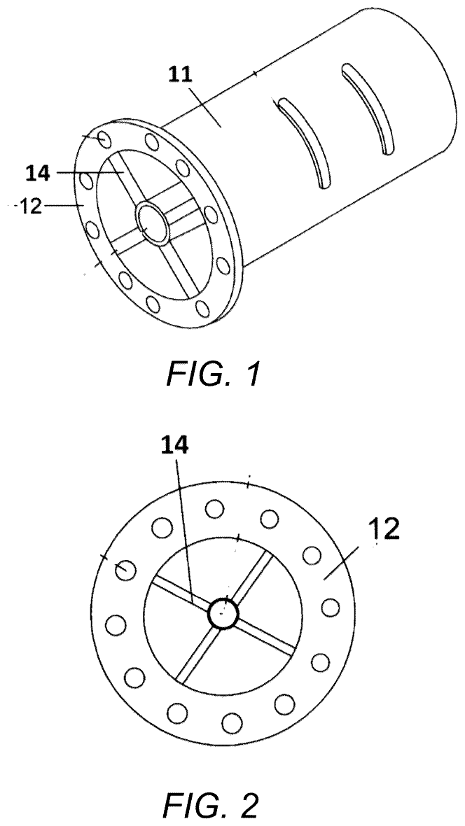

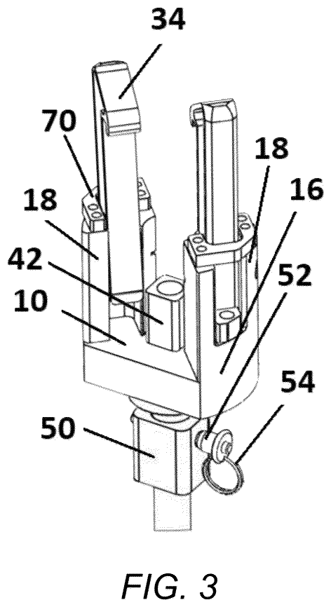

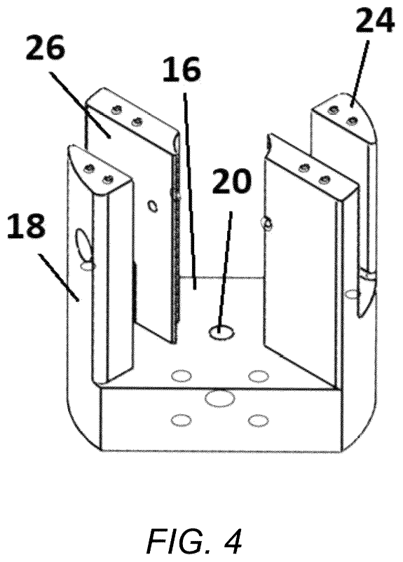

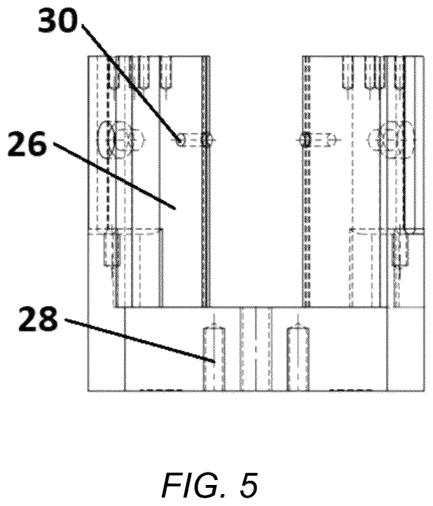

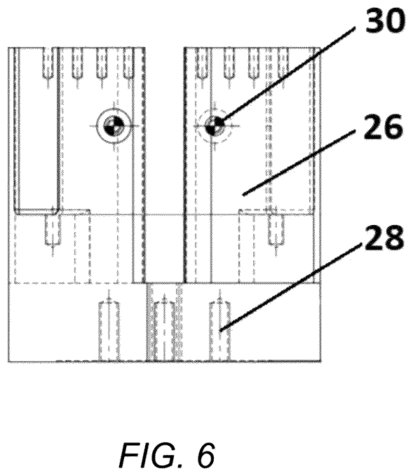

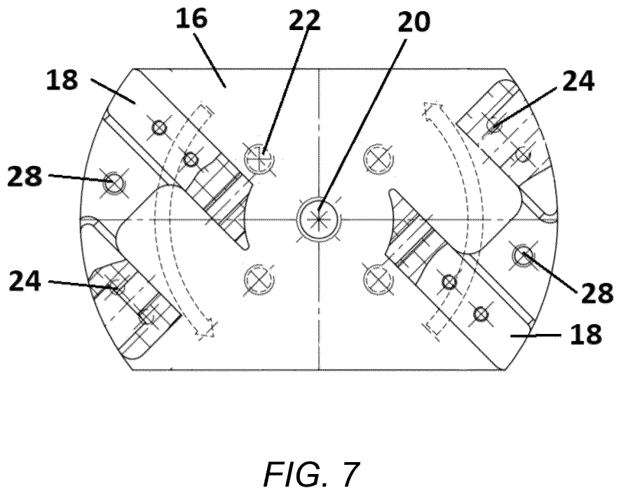

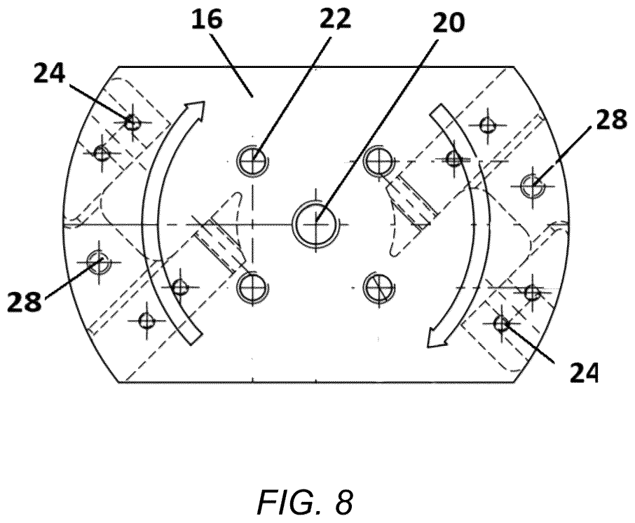

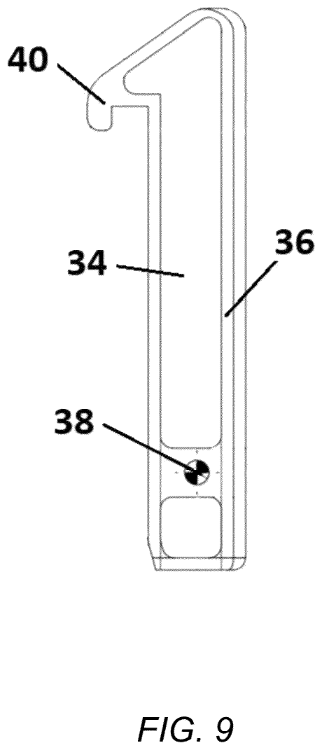

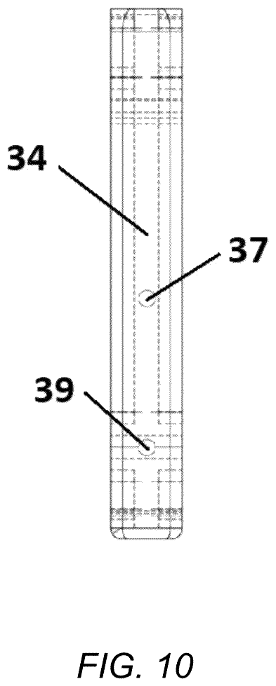

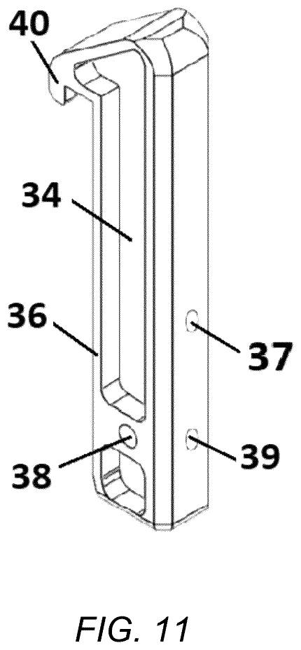

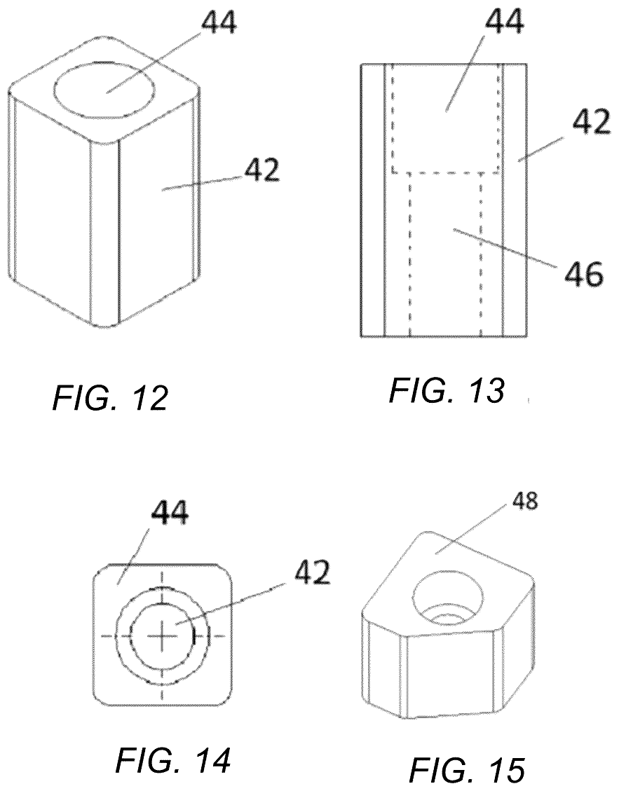

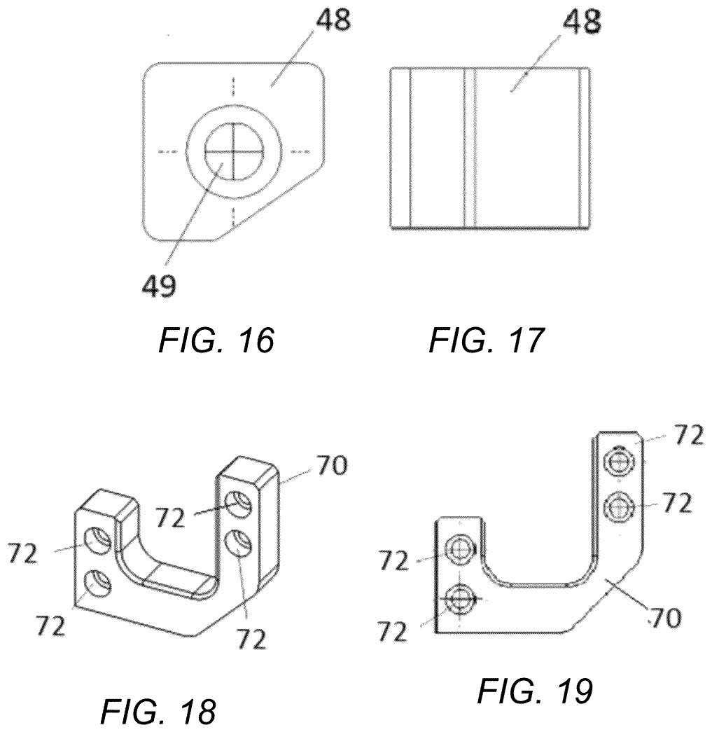

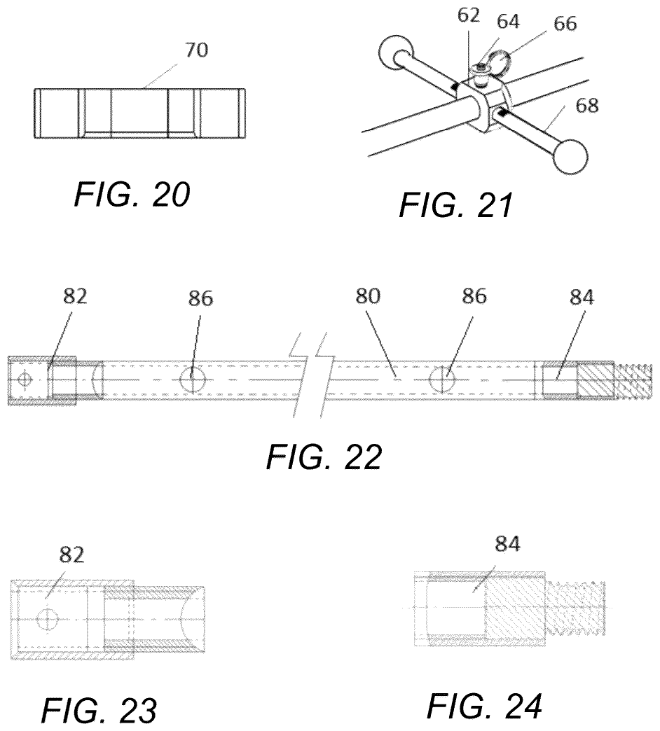

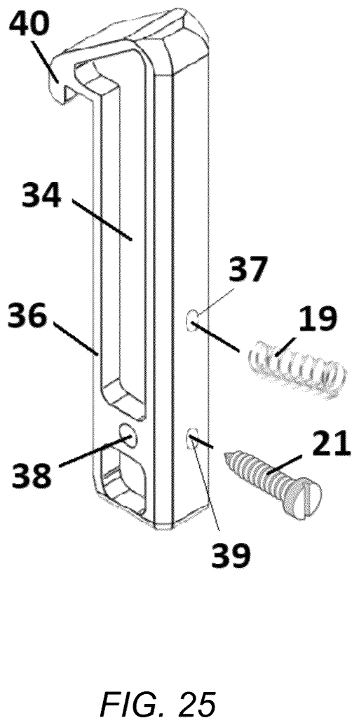

### LIST OF PARTS

10 pathway conduit extraction device
11 pathway conduit
12 pathway conduit flange
13 fastening hole
14 pathway conduit crosshead
16 quadrangular plate
19 compression spring
20 first center hole
21 screw
22 second set of holes
24 third set of holes
26 vertical posts
28 fourth set of holes
30 threaded holes
34 clamp tip bars
36 bar reinforcement veins
37 spring hole
38 bars' pin hole
39 screw hole
40 clamp-shape folding
42 square bolt
44 revision hole
46 tapped hole
48 union nut
62 crosshead bolt
64 bolt lock
66 lock ring
68 crosshead
70 u-shape stringer
80 telescopic posts
82 female end
84 male end

### DETAILED DESCRIPTION OF THE INVENTION

The present information disclosure describes a device consisting of a coupling which will be recessed in the concrete slab, for the formation of holes or openings in slabs for the purpose of passing various conduits which will conduct electrical wiring, telephone wiring, plumbing pipes, and other similar components.

The pathway conduits 11 consist of a rigid cylinder, which towards its lower part has a perpendicular flange-shaped base 12, that includes a plurality of holes 12, distributed in an equidistant way, which provide a fastening element to the formwork and thus fix the cylinder to the concrete. Towards the inner part of the cylinder, it has a small cylinder, joined by anchor ties 13, whose function will be to receive the extraction device 10 and extract it from the concrete slab by rotating the conduit 11, after it has set sufficiently to maintain its shape.

The extraction device 10, is shown unassembled and is arranged by the combination of a quadrangular plate 16, where its side faces comprise a curvature correlative to the diameter of a pathway conduit 11 and can rotate freely within the circular section of the pathway conduit 11.

Towards the flat surface of the quadrangular plate 16, there is a multiplicity of holes which will serve to hold each of the elements located on the surface of the quadrangular plate 16, and which are distributed as follows: a first central hole 20, followed by a second set of holes 22, which are placed around the first central hole 20, forming a square, a third set of holes 24, arranged at the upper ends of some posts 26, a fourth set of holes 28, at the bottom of the quadrangular plate 16, and which will hold some vertical posts 26.

This set of vertical posts 26 have a separation between each set, being placed at an inclination with respect to the horizontal axis and are fastened by means of sets of threaded holes 28 located on the quadrangular plate 16 and where some screws pass through.

Between each separation of the set of posts 26, there are some bars 34 where they comprise towards its periphery some reinforcement veins 36 to have greater resistance, and towards the lower part they have a perpendicular hole coincident with the perpendicular holes 38 of the posts 26, where there will be a shear pin and towards the upper end, it has a clamp-shaped fold 40, whose function will be to hold appropriately the pathway conduit's 11 crosshead 14.

Towards the rear of each of the bars 34, particularly towards the lower part, there is a hole 37, through which a compression spring 19 will be inserted, and further down, there is a second hole 39, threaded where a screw will be inserted.

The movement of each one of the bars 34, will be in a closed position, where the clamps are coincident, exerted by the pressure of the spring 19, and in this way at the moment of being introduced in the pathway conduit 12, these clamps will hold the crosshead 14, oscillating smoothly towards the interior and being able to extract the pathway conduit 12 from the reinforced concrete slab.

The perpendicular holes 38, are located at a height corresponding to two thirds of the total length of the bars 34, and are limited in their movement by means of U-shaped stringers 70 mounted on them, and supported in the upper side of the set of posts 26, through the holes 24.

Towards the central part of the quadrangular plate 16, it has a central hole 20 through which a square bolt 42, of considerable height, will be placed which has a revision hole 44 which projects to half of its length to join a threaded hole 46 through which a fastening screw will pass and through the lower part of the quadrangular plate 16, it attaches to a union nut 48, of square shape, with a cutout on one of its faces, threaded on the inside, as a means of fastening. Followed by union nut 48, it is attached to a square piece 50, which has a transverse locking pin and where this piece has a threaded hole in its lower part.

Since the pathway conduits 12 are located in the concrete slabs and the height between them is considerable, the proposed device comprises a plurality of telescopic posts 80, of an appropriate length, and which can be joined one by one, by means of a connection of threaded couplings, present at each end, towards the upper end, a male threaded coupling 84 and towards the other end a female threaded coupling 82 which is mounted towards the lower part of the square piece 50 and presents on its surface a multiplicity of perforations 86 distributed equidistantly at a previously set distance.

To move and rotate the extraction device 10, inside the pathway conduit 11 and to be able to extract it, a crosshead 68 is used, formed by an octagonal bolt 62, with a transversal central hole through which a section of the telescopic tube 80 passes and is coincident with a longitudinal hole 86, through which a pin 64 is inserted, which is a lock 64, with an extraction ring 66, and has on the sides of the octagonal bolt 62, two arms 68 placed between the non-aligned axes and which articulate the rotational movement on its axis with that of the telescopic tube 80.

As for the manner of using the invention it is quite simple.

To be able to extract the pathway conduit, 11, there is a crosshead 68 with a locking device 64 and extraction ring 66 which is placed in conjunction with the telescopic tubes 80.

Preferably, the rectangular plate 16, remains inside the cavity of the pathway conduit 11 and is fastened by means of the bars' 34 clamps 40, that are inserted into the crosshead 14 of the pathway conduit 11.

Once adjusted, it is simply rotated to extract the pathway conduit 11, where the piece is has ridges that allow it to slide and rotate easily on the outer surface, thus allowing the piece to come out.

To remove the bars 34 from the inside of the pathway conduit 12, screw 21 is pressed, which is located towards the bottom of the bars 34.

Therefore, we can consider that the present invention has its field of action for the extraction of pathway conduits located in the concrete slabs created for the passage of piping, electric wiring, telephone wiring and plumbing pipes.

I claim:

1. Extraction device for the removal of pathway conduits from concrete slabs, provides a useful tool for the recovery of pathway conduits and freeing the hole for the subsequent laying of pipes for the conduction of electrical and telephone wiring and water pipes, characterized by a combination of an extraction device 10, some telescopic poles 80 and a crosshead 68, where the extraction device 10 is arranged by the combination of:
a quadrangular plate 16, where its side faces comprise a curvature correlative to the diameter of a pathway conduit 11, and may rotate freely within the circular section;
multiple holes towards the flat surface of the quadrangular plate 16, for fastening the elements that will be attached to the surface of the plate;
a set of arms 18, having a spacing between each set, on the upper surface of the quadrangular plate 16, positioned at an inclination with respect to the horizontal axis and having threaded perforations;
a stringer 32, forming a “U” placed between the spacing of each set of posts 26, which serves as a stop to the post set 26;
a set of bars 34, which comprise reinforcement veins in its periphery to have greater resistance, placed between the separations of each set of posts 26, and present towards the lower part a perpendicular hole coincident with the perpendicular holes 28 of the posts 26, where a safety pin 38 will be located, and towards the upper end, it has a clamp-shaped fold 40
Towards the rear of each of the bars 34, particularly towards the lower part, there is a hole 37, where a compression spring 19 will be inserted, and further down, there is a second hole 39, threaded where a screw will be inserted.
Towards the central part of the quadrangular plate 16, it has a central hole 20 through which a square bolt 42 will be placed, of considerable height and which has a revision hole 44 which projects up to half of its length to join a threaded hole 46 through which a fastening screw will pass and through the lower part of the quadrangular plate 16, it attaches to a union nut 48, square in shape, with a cutout in one of its faces, threaded on the inside, as a means of fastening. Followed by union nut 48, it is joined to a square piece 50, which has a transversal locking ring and where this piece has a threaded hole in its lower part.
Since the pathway conduits 11 are located in the concrete slabs and the height between them is considerable, the proposed device comprises some telescopic posts 80 which are joined by means of a male threaded coupling 84 on a female threaded coupling 82 placed at the ends of the telescopic posts 60, and can be joined by a plurality of pipe sections forming a telescopic unit, which is mounted towards the lower part of the square piece 50.
Preferably, the rectangular plate 16, remains inside the cavity of the pathway conduit 11 and is fastened by means of the clamps 40 of each of the bars 34, which are inserted into the crosshead 14 of the pathway conduit. Once tightened, it is simply rotated to extract the pathway conduit 11, where said part has ridges that allow it to slide and rotate easily on the outer surface, and in this way, the piece will come out.
On the other hand, the telescopic posts 80, which are joined as many as necessary, arranged by tubes which comprise at their ends some threaded couplings as connecting elements, whose upper end has a male threaded coupling 84 and at the opposite or lower end, a female threaded coupling 82 so that they can be attached to each other, also on its straight surface, has a series of holes placed at regular distances,
a crosshead 68, for moving and rotating the extraction device 10, inside the pathway conduit 11, so that it can be extracted, consisting of an octagonal bolt 62, with a central hole through which a section of the telescopic tube 80 passes and coincides with a longitudinal hole through which a pin 64 is inserted, with a lock with an extraction ring 66, inside one of the holes of the telescopic tube 80, and of two arms 68 placed between the non-aligned axes and which articulate the turning motion.

2. Extraction device for the removal of pathway conduits from concrete slabs, characterized in that the flat surface of the quadrangular plate 16, comprises a multiplicity of holes arranged by a first central hole 20, followed by a second set of holes 22, which are placed around the first central hole 20, forming a square, in whose vertices are located each one of said holes 22, a third set of holes 24, placed in an inclined and symmetrical manner with respect to the horizontal axis in each corner of said square plate 16 and where said holes coincide with the third set of holes 24, placed in an inclined and symmetrical way with respect to the horizontal axis in each corner of the square plate 16 and where said holes are coincident with the third set of holes 24, located on the square plate 16 and where some screws pass to fasten the sets of posts 26 to the square plate 16.

3. Extraction device for the removal of pathway conduits from concrete slabs, characterized in that, the sets of arms 26 have some perpendicular holes 28, at a height corresponding to two thirds of the total length, as well as some second set of perforations 30 placed at the upper ends.

4. Extraction device for the removal of pathway conduits from concrete slabs, characterized in that, the sets of arms 26 have perpendicular holes 28, at a height corresponding to two thirds of the total length, as well as a second set of perforations 30 placed at the upper ends.

5. Extraction device for the removal of pathway conduits from concrete slabs, characterized in that, the set of bars 34, has a clamp-shaped fold 40, which function will be to properly hold the pathway conduit's 11 crosshead 68.

6. Extraction device for the removal of pathway conduits from concrete slabs, characterized in that, each of the bars 34, will be in closed position, where the clamps are presented coincident, exerted by the pressure of the spring 19 and the movement of each of the bars 34, is performed from its position coincident with the bars 34, inwards, oscillating smoothly.

7. Extraction device for the removal of pathway conduits from concrete slabs, characterized in that the pathway conduits 11 located in the concrete slabs and between them the height is considerable, are removed by means of the union of several telescopic tubes 80, attached one by one by means of threaded coupling connections that are in each section of tube.

8. Extraction device for the removal of pathway conduits from concrete slabs, characterized in that the telescopic tubes 80 have sets of male threaded couplings 84 at one end and a female threaded coupling 82 at the other end.

9. Extraction device for the removal of pathway conduits from concrete slabs, characterized in that the telescopic tubes 80, comprise on their surface a multiplicity of perforations 86 distributed equidistantly at a previously set distance.

10. Extraction device for the removal of pathway conduits from concrete slabs, characterized for using a crosshead 68, consisting of an octagonal nut 62, with a central transverse hole and two arms 32 placed between the non-aligned axes and which articulate the rotational movement, and because it is fastened by means of a pin 64 and with a ring lock 66.

11. Extraction device for the removal of pathway conduits from concrete slabs, characterized in that towards the rear of each one of the bars 34, in the lower part, it has a hole 37, where a compression spring 19 will be inserted, and further down, a second hole 39 is located, threaded where a screw 21 will be inserted.

12. Extraction device for the removal of pathway conduits from concrete slabs, characterized in that once the pathway conduit 12 has been extracted, screw 21 is pressed and the two arms 32 are opened.
